(19) United States
(12) Patent Application Publication
(10) Pub. No.: US 2024/0141188 A1
(43) Pub. Date: May 2, 2024

(54) PREPARATION METHOD OF HIGH REFRACTIVE INDEX INK, AND DISPLAY PANEL

(71) Applicant: SHENZHEN CHINA STAR OPTOELECTRONICS SEMICONDUCTOR DISPLAY TECHNOLOGY CO., LTD, Shenzhen (CN)

(72) Inventors: Miao DUAN, Shenzhen (CN); Miao ZHOU, Shenzhen (CN); Lixuan CHEN, Shenzhen (CN)

(21) Appl. No.: 18/088,591

(22) Filed: Dec. 25, 2022

(30) Foreign Application Priority Data
Oct. 27, 2022 (CN) 202211327727.1

(51) Int. Cl. C09D 11/037; C09D 7/80; C09D 11/033; C09D 11/102; G02B 1/111

(52) U.S. Cl. CPC C09D 11/037; C09D 7/80; C09D 11/033; C09D 11/102; G02B 1/111

(57) ABSTRACT

Embodiments of the present disclosure disclose a preparation method of high refractive index ink and a display panel. The method for preparing high refractive index ink, comprising: providing a nano-metal oxide dispersion; performing ozone treatment on the nano-metal oxide dispersion to obtain the ozone treated nano-metal oxide dispersion; mixing the ozone-treated nano-metal oxide dispersion with a plurality of preset solutions according to a predetermined weight ratio to form a mixed solution; performing ball milling treatment on the mixed solution to obtain the ball-milled mixed solution; and heating the ball-milled mixed solution to obtain the high refractive index ink. According to the present disclosure, the nano-metal oxide dispersion is subjected to ozone and ball milling treatment, thereby improving the dispersibility of the nano-metal oxide particles in the high refractive index ink.

### CROSS REFERENCE TO RELATED APPLICATIONS

This application claims the benefit of priority of Chinese Application No. 202211327727.1 filed on Oct. 27, 2022. The contents of the above applications are all incorporated by reference as if fully set forth herein in their entirety.

### FIELD

The present disclosure belongs to the technical field of display panels, and in particularly, relates to a preparation method of high refractive index ink, and a display panel.

### BACKGROUND

With the continuous development of display panel technologies, the display effect of display panels is increasingly required. In order to improve the display effect of display panels, a functional optical film layer, such as a low reflective film layer, is usually provided in the display panel to reduce the reflective performance of the display panel.

High refractive index materials can be used to prepare the low reflective film layer. A high refractive index ink, serving as the high refractive index material, can be divided into an organic optical resin system and an inorganic nanocomposite resin system, wherein in the high refractive index ink prepared by the inorganic nanocomposite resin system, inorganic nanoparticles has the problem of poor dispersibility.

### SUMMARY

Embodiments of the present disclosure provide a high refractive index ink and a preparation method thereof, and a display panel and a preparation method thereof, thereby improving the dispersibility of nano-metal oxide particles in the high refractive index ink.

In a first aspect, embodiments of the present disclosure provide a method for preparing a high refractive index ink, comprising steps of:
providing a nano-metal oxide dispersion;
performing ozone treatment on the nano-metal oxide dispersion to obtain the ozone treated nano-metal oxide dispersion;
mixing the ozone-treated nano-metal oxide dispersion with a plurality of preset solutions according to a predetermined weight ratio to form a mixed solution;
performing ball milling treatment on the mixed solution to obtain the ball-milled mixed solution; and
heating the ball-milled mixed solution to obtain the high refractive index ink.

Optionally, in some embodiments, the step of performing ozone treatment on the nano-metal oxide dispersion to obtain the ozone treated nano-metal oxide dispersion comprises:
feeding ozone gas into the nano-metal oxide dispersion over a predetermined time; and
stirring the nano-metal oxide dispersion and the ozone gas to obtain the ozone treated nano-metal oxide dispersion.

Optionally, in some embodiments, the stirring is performed for 10-60 minutes.

Optionally, in some embodiments, the plurality of preset solutions include a coupling agent, a resin, an organic solvent, and a curing agent, wherein the ozone-treated nano-metal oxide dispersion includes the ozone-treated nano-zirconium oxide dispersion, the coupling agent includes a silane coupling agent, the resin includes at least one of an epoxy acrylate resin and a polyurethane acrylate resin, the organic solvent includes at least one of an ester solvent, an alcohol solvent, and an ether solvent, and the curing agent includes an isocyanate;
wherein the step of mixing the ozone-treated nano-metal oxide dispersion with the plurality of preset solutions according to the predetermined weight ratio to form the mixed solution comprises:
mixing 5-30 wt % of the ozone-treated nano-zirconium oxide dispersion, 0.1-10 wt % of the silane coupling agent, 5-30 wt % of the resin, 10-40 wt % of the organic solvent, and 0.1-3 wt % of the curing agent to form the mixed solution.

Optionally, in some embodiments, the plurality of preset solutions further include an auxiliary agent including at least one of a leveling agent, a wetting agent, and an antistatic agent;
wherein the step of mixing the ozone-treated nano-metal oxide dispersion with the plurality of preset solutions according to the predetermined weight ratio to form the mixed solution comprises:
mixing 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent to form the mixed solution.

Optionally, in some embodiments, the step of performing ball milling treatment on the mixed solution to obtain the ball-milled mixed solution comprises:
putting the mixed solution into a ball mill, and controlling the ball mill to perform ball milling treatment at a rotational speed of 200-2000 r/min for 10 to 60 minutes to obtain the ball-milled mixed solution.

Optionally, in some embodiments, the step of heating the ball-milled mixed solution to obtain the high refractive index ink comprises:
heating the ball-milled mixed solution at a temperature of 50-80 degrees Celsius for 1-1.5 hours to obtain the high refractive index ink.

In a second aspect, embodiments of the present disclosure further provide another method for preparing a high refractive index ink, comprising steps of:
providing a nano-metal oxide dispersion;
performing ozone treatment on the nano-metal oxide dispersion to obtain the ozone treated nano-metal oxide dispersion;
separately performing ball milling treatment on the ozone-treated nano-metal oxide dispersion and a plurality of preset solutions to obtain the ball-milled nano-metal oxide dispersion and the ball-milled plurality of preset solutions;
mixing the ball-milled nano-metal oxide dispersion with the ball-milled plurality of preset solutions according to a predetermined weight ratio to form a mixed solution;
heating the mixed solution to obtain the high refractive index ink.

Optionally, in some embodiments, the plurality of preset solutions include a coupling agent, a resin, an organic solvent, and a curing agent, the ozone treated nano-metal oxide dispersion includes an ozone treated nanometallic zirconium oxide dispersion, the coupling agent includes a silane coupling agent, the resin includes at least one of an epoxy acrylate resin and a polyurethane acrylate resin, the organic solvent includes at least one of an ester solvent, an alcohol solvent, and an ether solvent, the curing agent includes an isocyanate;
wherein the step of separately performing ball milling treatment on the ozone-treated nano-metal oxide dispersion and the plurality of preset solutions to obtain the ball-milled nano-metal oxide dispersion and the ball-milled plurality of preset solutions comprises:
controlling a ball mill to perform ball milling treatment on the ozone-treated nano-zirconium oxide dispersion, the silane coupling agent, the resin, the organic solvent, and the curing agent at a rotational speed of 200-2000 r/min for 10-60 minutes to obtain the ball-milled nano-zirconium oxide dispersion, the ball-milled silane coupling agent, the ball-milled resin, the ball-milled organic solvent, and the ball-milled curing agent.

Optionally, in some embodiments, the plurality of preset solutions further include an auxiliary agent including at least one of a leveling agent, a wetting agent, and an antistatic agent;
wherein the step of separately performing ball milling treatment on the ozone-treated nano-metal oxide dispersion and the plurality of preset solutions to obtain the ball-milled nano-metal oxide dispersion and the ball-milled plurality of preset solutions comprises:
controlling the ball mill to perform ball milling treatment on the ozone-treated nano-zirconium oxide dispersion, the silane coupling agent, the resin, the organic solvent, and the curing agent, and the auxiliary agent at a rotational speed of 200-2000 r/min for 10 to 60 minutes to obtain the ball-milled nano-zirconium oxide dispersion, the ball-milled silane coupling agent, the ball-milled resin, the ball-milled organic solvent, the ball-milled curing agent, and the ball-milled auxiliary agent.

Optionally, in some embodiments, the step of mixing the ball-milled nano-metal oxide dispersion with the ball-milled plurality of preset solutions according to the predetermined weight ratio to form the mixed solution comprises:
mixing 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent to form the mixed solution.

Optionally, in some embodiments, the step of mixing the ball-milled nano-metal oxide dispersion with the ball-milled plurality of preset solutions according to the predetermined weight ratio to form the mixed solution comprises:
mixing 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent and 0.1-3 wt % of the ball-milled auxiliary agent to form the mixed solution.

In a third aspect, embodiments of the present disclosure further provide a high refractive ink prepared by the method for preparing the high refractive ink according to any one of the above.

In a fourth aspect, embodiments of the present disclosure further provide a display panel comprising:
a substrate base;
a first film layer disposed on the substrate base, wherein the first film layer is prepared from a high refractive index ink obtained by the method for preparing the high refractive index ink according to any one of the above discussion;
a second film layer disposed on a side of the first film layer away from the substrate base, wherein a refractive index of the second film layer is less than a refractive index of the first film layer.

Optionally, in some embodiments, the display panel comprises a plurality of first film layers and a plurality of second film layers, wherein the plurality of first film layers and the plurality of second film layers are stacked in sequence, and two adjacent first film layers or two adjacent second film layers are disposed at intervals.

In a fifth aspect, embodiments of the present disclosure further provide a method for manufacturing a display panel, comprising steps of:
providing a substrate base;
coating a high refractive index ink obtained by the method for preparing the high refractive index ink according to any one of the above discussion on the substrate base;
curing the high-emissivity ink to form a first film layer;
forming a second film layer on the first film layer, wherein a refractive index of the second film layer is less than a refractive index of the first film layer.

The preparation method of the high refractive index ink provided in the embodiments of the present disclosure comprises providing a nano-metal oxide dispersion; performing ozone treatment on the nano-metal oxide dispersion to obtain the ozone treated nano-metal oxide dispersion; mixing the ozone-treated nano-metal oxide dispersion with a plurality of preset solutions according to a predetermined weight ratio to form a mixed solution; performing ball milling treatment on the mixed solution to obtain the ball-milled mixed solution; heating the ball-milled mixed solution to obtain a high refractive index ink. According to the embodiments of the present disclosure, the nano-metal oxide dispersion is subjected to ozone treatment, the active sites on the surfaces of the nano-metal oxide particles are increased by the strong oxidation of ozone, and the surfaces of the nano-metal oxide particles are further modified by ball milling treatment, thereby improving the dispersibility of the nano-metal oxide particles in the high refractive index ink.

### BRIEF DESCRIPTION OF THE DRAWINGS

The technical solutions of the present disclosure and the beneficial effects thereof will be apparent from the following detailed description of specific embodiments of the present disclosure, in conjunction with the accompanying drawings.

FIG. 1 is a schematic flowchart of a process for preparing a high refractive index ink according to an embodiment of the present disclosure.

FIG. 2 is a schematic flowchart of another method for preparing a high refractive index ink according to an embodiment of the present disclosure.

FIG. 3 is a schematic view of a first structure of a display panel according to an embodiment of the present disclosure.

FIG. 4 is a schematic view of a second structure of a display panel according to an embodiment of the present disclosure.

FIG. 5 is a schematic flowchart of a method for preparing a display panel according to an embodiment of the present disclosure.

### DETAILED DESCRIPTION OF EMBODIMENTS

Technical solutions in embodiments of the present disclosure will be clearly and completely described below in conjunction with drawings in the embodiments of the present disclosure. It is apparent that the described embodiments are only a part of embodiments of the present disclosure, rather than all the embodiments. Based on the embodiments in the present disclosure, all other embodiments obtained by those skilled in the art without creative effort fall within the protection scope of the present disclosure.

Unless defined otherwise, technical or scientific terms used in the present disclosure shall have the general meanings appreciated by those of ordinary skill in the art to which the present disclosure pertains. Terms, such as “first”, “second”, and the like as used herein, do not indicate any order, number, or importance, but are merely used to distinguish between different components. Similarly, terms “a”, “an”, or “the” and the like do not indicate a quantitative limitation, but rather the presence of at least one. Phases “include”, “including”, “comprise”, “comprising” and the like are intended to mean that an element or article preceding the phases encompasses an element or articles and equivalents thereof recited after the phases, without excluding other elements or articles. Phases “connect” and “couple” and the like are not limited to physical or mechanical connections, but may include electrical connections, regardless of direct or indirect connections. Terms such as “up”, “down”, “left”, “right”, etc. are only used to indicate relative position relationships. When the absolute position of the object being described changes, the relative position relationship may also change accordingly.

With the development of the display panel technology, the display effect of the display panel is increasingly required. In order to improve the display effect of the display panel, a functional optical film layer, such as a low reflective film layer, is usually provided in the display panel to reduce the reflective performance of the display panel.

The high refractive index material can be used to prepare a low reflection film layer, and the high refractive index ink as a high refractive index material can be divided into an organic optical resin system and an inorganic nanocomposite resin system. The high refractive index ink prepared by the organic optical resin system usually contains a large amount of benzene rings and the like, resulting in an adverse phenomenon such as yellowing during long-term use, thereby affecting the display effect of the display panel prepared by using the high refractive index ink. The high refractive index ink prepared by the inorganic nanocomposite resin system is generally composed of high refractive index inorganic nanoparticles and an organic polymer system, and the adjustability of the refractive index can be achieved by adjusting the content of the inorganic substance. In the process of preparing the high-refraction ink by using the inorganic nano-composite resin system, the inorganic nanoparticles are usually subjected to surface modification and then to dispersion treatment. However, the inorganic nanoparticles have a poor surface modification effect due to few surface active sites, resulting in a problem that the inorganic nanoparticles have poor dispersibility.

To solve the above problems, an embodiment of the present disclosure provides a method for preparing a high refractive index ink. Referring to FIG. 1, it is a schematic flowchart of a method for preparing a high refractive index ink according to an embodiment of the present disclosure. The high refractive index ink obtained by the method can be used to prepare a low-reflection film layer, and a display panel prepared by using the low-reflection film layer can reduce reflection of light, thereby improving brightness, clarity, and the like of the display panel to allow the display panel to achieve a relative desirable display effect. The preparation method of the high refractive index ink has specific steps as follows:

101. Providing a nano-metal oxide dispersion;

In an embodiment, the nano-metal oxide dispersion is first provided before the preparation of the high refractive index ink through the inorganic nanocomposite resin system. The nano-metal oxide dispersion may be a nanoscale metal oxide dispersion. That is, the metal oxide particles in the nanoscale metal oxide dispersion, such as a nano-zirconium oxide dispersion, are nano-sized. The nano-zirconium oxide dispersion comprises a certain amount of nano-zirconium oxide particles. For example, nano-zirconium oxide particles of 40-70% are contained in the nano-zirconium oxide dispersion. That is, the nano-zirconium oxide particles account for 40-70% of the nano-zirconium oxide dispersion, for example, 40%, 50%, 60%, 70%, and so on of the nano-zirconium oxide dispersion. The nano-zirconium oxide particles may be crystal grains having a single form or mixed form, which have a particle size of 5-50 nm, for example, 5 nm, 10 nm, 15 nm, 20 nm, 25 nm, 30 nm, 35 nm, 40 nm, 45 nm, 50 nm, and so on. The zirconium oxide has a chemical formula of ZrO₂, which is a primary oxide of zirconium metal.

It is to be noted that, the nano-zirconium oxide particles are generally white, odorless and tasteless crystals and are poorly soluble in water, hydrochloric acid and dilute sulfuric acid. They have an inert chemical property, and have characteristics such as high melting points, high resistivity, low thermal expansion coefficients, and high refractive indexes, thereby becoming an important inorganic material with high temperature resistance and high refractive index. The nano-zirconium oxide particles have few active sites on their surfaces, thereby resulting in difficult modification and poor dispersibility.

102. Performing ozone treatment on the nano-metal oxide dispersion to obtain the ozone-treated nano-metal oxide dispersion

In order to solve the problem of difficult modification due to less surface active sites in the nano-metal oxide dispersion, such as the nano-zirconium oxide dispersion, ozone treatment is carried out on the nano-metal oxide dispersion, such as the nano-zirconium oxide dispersion in an embodiment. It is to be noted that ozone has a chemical formula of O₃, which has a strong oxidizing property and can be used as a strong oxidizing agent in a catalytic reaction.

Optionally, ozone gas may be fed into the nano-metal oxide dispersion over a period of time; and the nano-metal oxide dispersion and the ozone gas are stirred uniformly, so that the nano-metal oxide particles in the nano-metal oxide dispersion are catalytically reacted with the ozone gas to obtain the ozone-treated nano-metal oxide dispersion.

Specifically, a circulating ozone gas is continuously fed into the nano-metal oxide dispersion such as the nano-zirconium oxide dispersion, and the nano-zirconium oxide dispersion and the ozone gas are uniformly stirred by using a stirrer. In the uniform stirring process, the nano-zirconium oxide particles in the nano-zirconium oxide dispersion are catalytically reacted with the ozone gas based on the strong oxidation of the ozone gas, so that a plurality of hydroxyl radicals are generated on the surfaces of the nano-zirconium oxide particles. The plurality of hydroxyl radicals have extremely strong electron-obtaining capacity, i.e., oxidation capacity, so that the surface of each of the nano-zirconium oxide particles forms a plurality of active sites due to electron loss, thus being well modified by ozone treatment to obtain a final product after catalytic reaction, namely, the ozone-treated nano-zirconium oxide dispersion.

The time for feeding the ozone gas may be specifically set according to actual conditions, and is not specifically limited herein. The time of the uniform stirring treatment may be 10 to 60 minutes, such as 10 minutes, 20 minutes, 30 minutes, 40 minutes, 50 minutes, 60 minutes, and so on. The stirrer used to perform the uniform stirring treatment may be a propeller stirrer, a turbine stirrer, an anchor stirrer, a helical ribbon stirrer, a magnetic stirrer, a heating magnetic stirrer, a folding stirrer, a side-entering stirrer, or the like.

103. Mixing the ozone-treated nano-metal oxide dispersion with a plurality of preset solutions according to a predetermined weight ratio to form a mixed solution.

The ozone-treated nano-metal oxide dispersion is mixed with the plurality of preset solutions according to the predetermined weight ratio to form the mixed solution. The ozone-treated nano-metal oxide dispersion may include the ozone-treated nano-zirconium oxide dispersion. The plurality of preset solutions may include a coupling agent, a resin, an organic solvent, a curing agent, and the like.

Specifically, the coupling agent can be used as a surface modifier, which can improve the dispersion and adhesion property of an inorganic metal oxide. The coupling agent may include a silane coupling agent. The silane having an epoxy end or an amino end is generally selected as the silane coupling agent, for example, a silane coupling agent KH-550, a silane coupling agent KH-560, and the like. Among them, the silane coupling agent KH-550 (i.e., γ-aminopropyltriethoxysilane) and the silane coupling agent KH-560 (i.e., γ-glycidoxypropyltrimethoxysilane) are good adhesives.

The resin may include at least one of an epoxy acrylate resin and a polyurethane acrylate resin. The epoxy acrylate resin is a modified epoxy resin obtained by reacting epoxy resin and acrylic acid and dissolving them in styrene, and it has good curability and moldability. The molecule of the polyurethane acrylate resin contains acrylic functional group(s) and urethane bond(s), and thus the cured adhesive has high abrasion resistance, adhesion, flexibility and peel strength and excellent low temperature resistance of the polyurethane, as well as excellent optical performance and weather resistance of the polyacrylate, so it is a radiation curable material with excellent comprehensive properties.

The organic solvent may include at least one of an ester solvent, an alcohol solvent, and an ether solvent, also may be a ketone solvent, an aromatic hydrocarbon solvent, or an amide solvent. The ester solvent may include propylene glycol methyl ether acetate, ethyl acetate, butyl acetate, and so on. The alcohol solvent may include methanol, ethanol, propanol, n-butanol, and so on. The ether solvent may include tetrahydrofuran, propylene glycol methyl ether, ethylene glycol monomethyl ether, and diethylene glycol monobutyl ether, and so on. The ketone solvent may include acetone, butanone, methyl isobutyl ketone, and so on. The aromatic hydrocarbon solvent may include toluene, xylene, ethylbenzene, and so on. The amide solvent may include dimethylformamide, N-dimethylammonium acetate, N-methylpyrrolidone, and so on. The organic solvent can serve to dilute and adjust the viscosity of the high refractive index ink.

The curing agent may be an ambient curing agent or a heat curing agent. The curing agent may include isocyanates, fatty amines, polyamides, polyamines, anhydrides, and so on. The addition of the curing agent allows these resins to undergo an irreversible process of change to achieve curing and cross-linking.

Optionally, the ozone-treated nano-zirconium oxide dispersion is mixed with the coupling agent, the resin, the organic solvent, and the curing agent in a predetermined weight ratio to form a mixed solution. Specifically, 5-30 wt % of the ozone-treated nano-zirconium oxide dispersion, 0.1-10 wt % of the silane coupling agent, 5-30 wt % of the resin, 10-40 wt % of the organic solvent, and 0.1-3 wt % of the curing agent are mixed to form a mixed solution. The mixed solution may comprise 5 wt % of the ozone-treated nano-zirconium oxide dispersion, 0.1 wt % of the silane coupling agent, 5 wt % of the resin, 10 wt % of the organic solvent, and 0.1 wt % of the curing agent, or the mixed solution may comprise 30 wt % of the ozone-treated nano-zirconium oxide dispersion, 10 wt % of the silane coupling agent, 30 wt % of the resin, 40 wt % of the organic solvent, and 3 wt % of the curing agent.

In addition, the plurality of preset solutions may also include auxiliary agents. The auxiliary agent may include at least one of a leveling agent, a wetting agent, and an antistatic agent. The leveling agent can effectively reduce the surface tension of the high refractive index ink, and improve the leveling property and uniformity thereof. The wetting agent, as a surfactant, can also reduce the surface tension of the high refractive index ink. The antistatic agent can reduce the surface electrostatic accumulation of the high refractive index ink and improve the stability thereof.

Optionally, the ozone-treated nano-zirconium oxide dispersion is mixed with the coupling agent, the resin, the organic solvent, the curing agent, and the auxiliary agent in a predetermined weight ratio to form a mixed solution. Specifically, 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent are mixed to form a mixed solution. The mixed solution may comprise 5 wt % of the ozone-treated nano-zirconium oxide dispersion, 0.1 wt % of the silane coupling agent, 5 wt % of the resin, 10 wt % of the organic solvent, 0.1 wt % of the curing agent, and 0.1 wt % of the auxiliary agent, or the mixed solution may comprise 30 wt % of the ozone-treated nano-zirconium oxide dispersion, 10 wt % of the silane coupling agent, 30 wt % of the resin, 40 wt % of the organic solvent, 3 wt % of the curing agent, and 3 wt % of the auxiliary agent.

104. Subjecting the mixed solution to ball milling treatment to obtain the ball-milled mixed solution

Since the above-mentioned mixed solution is formed by mixing individual solutions, the plurality of solutions in the mixed solution are not completely contacted with each other. Therefore, the mixed solution can be subjected to ball milling treatment to mix uniformly.

Optionally, the mixed solution is placed in a ball mill and subjected to the ball milling treatment at a rotational speed of 200-2000 r/min such as 200 r/min, 500 r/min, 1000 r/min, 1500 r/min, or 2000 r/min for 10 to 60 minutes (e.g., 10 minutes, 30 minutes, 40 minutes, 50 minutes, or 60 minutes), to obtain the ball-milled mixed solution. Here, 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent can be mixed and then placed into a ball mill to form a mixed solution. The multiple solutions can be contacted to each other more fully by ball milling treatment to obtain a more uniform mixed solution, i.e., the ball-milled mixed solution. The ball mill may be a planetary ball mill or the like.

It is to be noted that the ozone-treated nano-zirconium oxide dispersion in the mixed solution is subjected to ball milling treatment so that the surfaces of the nano-zirconium oxide particles contained therein is more fully contacted with other solutions such as the coupling agent. That is, the surface modification of the nano-zirconium oxide particles by the coupling agent may be strengthened by a mechanical force of the ball milling treatment, thereby further increasing the number of surface active sites of the nano-zirconium oxide particles and increasing the dispersibility of the nano-zirconium oxide particles.

105. Subjecting the ball-milled mixed solution to a heat treatment to obtain a high refractive index ink.

The ball-milled mixed solution is subjected to a heating treatment. Specifically, the ball-milled mixed solution is heated at a temperature of 50-80 degrees Celsius for 1-1.5 hours to obtain the high refractive index ink. For example, the ball-milled mixed solution is removed from the ball mill tank in the ball mill, and is placed into a water bath for heating at 50-80° C., such as 50° C., 60° C. or 70° C. for 1-1.5 hours, such as 1 hour or 1.5 hours, and the final product obtained is the high refractive index ink.

It is to be noted that the method for preparing the high refractive index ink provided in the embodiments of the present disclosure produces a high refractive index ink of an inorganic nano-composite resin system, which uses an inorganic material having a high refractive index, such as a nano-zirconium oxide dispersion, so that the prepared high refractive index ink has stable chemical properties and strong reliability. Furthermore, in the embodiments, ozone and ball milling treatments are performed on the nano-zirconium oxide dispersion to solve the problem of poor dispersibility caused by few surface active groups and poor surface modification effect of nano particles of the inorganic materials in the prior art, so that the dispersibility of the metal oxide particles in the high refractive index ink is improved.

As can be seen from the above, according to the embodiments, the nano-metal oxide dispersion is provided and performed ozone treatment to obtain the ozone-treated nano-metal oxide dispersion, then the ozone-treated nano-metal oxide dispersion and a plurality of preset solutions are mixed in a predetermined weight ratio to form a mixed solution. Then, the mixed solution is subjected to ball milling treatment to obtain the ball-milled mixed solution, and finally the ball-milled mixed solution is subjected to heat treatment to obtain a high refractive index ink. By ozone treatment of the nano-metal oxide dispersion, the active sites on the surfaces of the nano-metal oxide particles are increased by strong oxidation of ozone. By ball milling treatment, the surfaces of the nano-metal oxide particles are further modified, thereby improving the dispersibility of the nano-metal oxide particles in the high refractive index ink.

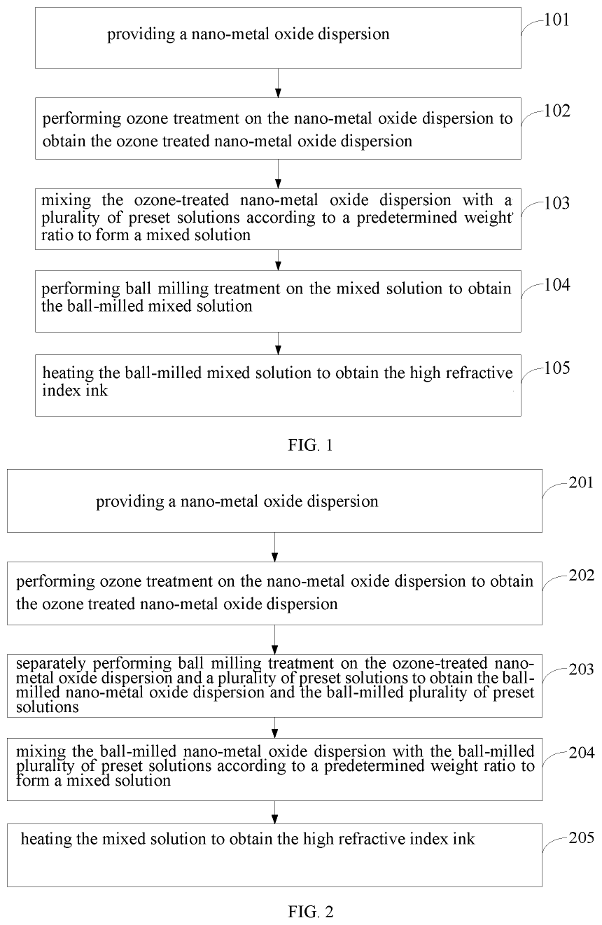

In addition, embodiments of the present disclosure further provide another method of preparing a high refractive index ink. Referring to FIG. 2, it is a schematic flowchart of another method for preparing a high refractive index ink according to an embodiment of the present disclosure. The method of preparing a high refractive index ink has specific steps as follows:

201. Providing a nano-metal oxide dispersion.

In the present embodiment, the preparation of the high refractive index ink by the inorganic nanocomposite resin system requires first providing a nano-metal oxide dispersion, wherein the nano-metal oxide dispersion may be a nanoscale metal oxide dispersion, that is, the metal oxide in the nanoscale metal oxide dispersion is a nanoscale particle such as a nano-zirconium oxide dispersion, and the nano-zirconium oxide dispersion contains a certain amount of nano-zirconium oxide particles, that is, the nano-zirconium oxide particles contain 40-70% in the nano-zirconium oxide dispersion; that is, the nano-zirconium oxide particles account for 40-70% of the nano-zirconium oxide dispersion, that is, the nano-zirconium oxide particles account for 40%, 50%, 60%, 70%, and the like of the nano-zirconium oxide dispersion. The nano-zirconium oxide particles may be a single crystal grain or a mixed crystal grain, and the particle size of the single crystal grain or the mixed crystal grain may be 5-50 nm. For example, the particle size of the single crystal grain or the mixed crystal grain is 5 nm, 10 nm, 15 nm, 20 nm, 25 nm, 30 nm, 35 nm, 40 nm, 45 nm, 50 nm, and the like. The zirconium oxide has a chemical formula of ZrO₂, and is a main oxide of zirconium metal.

It is to be noted that the nano-zirconium oxide particles are generally white, odorless and tasteless crystals and are poorly soluble in water, hydrochloric acid and dilute sulfuric acid. They have an inert chemical property, and have characteristics such as high melting points, high resistivity, low thermal expansion coefficients, and high refractive indexes, thereby becoming an important inorganic material with high temperature resistance and high refractive index. The nano-zirconium oxide particles have few active sites on their surfaces, thereby resulting in difficult modification and poor dispersibility.

202. Performing ozone treatment on the nano-metal oxide dispersion to obtain the ozone-treated nano-metal oxide dispersion

In order to solve the problem of difficult modification due to few surface active sites in the nano-metal oxide dispersion, such as the nano-zirconium oxide dispersion, ozone treatment is carried out on the nano-metal oxide dispersion, such as the nano-zirconium oxide dispersion in an embodiment. It is to be noted that ozone has a chemical formula of O₃, which has a strong oxidizing property and can be used as a strong oxidizing agent in a catalytic reaction.

Optionally, ozone gas may be fed into the nano-metal oxide dispersion over a period of time; and the nano-metal oxide dispersion and the ozone gas are stirred uniformly, so that the nano-metal oxide particles in the nano-metal oxide dispersion are catalytically reacted with the ozone gas to obtain the ozone-treated nano-metal oxide dispersion

Specifically, a circulating ozone gas is continuously fed into the nano-metal oxide dispersion such as the nano-zirconium oxide dispersion, and the nano-zirconium oxide dispersion and the ozone gas are uniformly stirred by using a stirrer. In the uniform stirring process, the nano-zirconium oxide particles in the nano-zirconium oxide dispersion are catalytically reacted with the ozone gas based on the strong oxidation of the ozone gas, so that a plurality of hydroxyl radicals are generated on the surfaces of the nano-zirconium oxide particles. The plurality of hydroxyl radicals have extremely strong electron-obtaining capacity, i.e., oxidation capacity, so that the surface of each of the nano-zirconium oxide particles forms a plurality of active sites due to electron loss, thus being well modified by ozone treatment to obtain a final product after catalytic reaction, namely, the ozone-treated nano-zirconium oxide dispersion.

The time for feeding the ozone gas may be specifically set according to actual conditions, and is not specifically limited herein. The time of the uniform stirring treatment may be 10 to 60 minutes, such as 10 minutes, 20 minutes, 30 minutes, 40 minutes, 50 minutes, 60 minutes, and so on. The stirrer used to perform the uniform stirring treatment may be a propeller stirrer, a turbine stirrer, an anchor stirrer, a helical ribbon stirrer, a magnetic stirrer, a heating magnetic stirrer, a folding stirrer, a side-entering stirrer, or the like.

203. Subjecting the ozone-treated nano-metal oxide dispersion and the plurality of preset solutions to ball-milling treatment separately to obtain the ball-milled nano-metal oxide dispersion and the ball-milled plurality of preset solutions, respectively

The ozone-treated nano-metal oxide dispersion may include the ozone-treated nano-zirconium oxide dispersion. The plurality of preset solutions may include a coupling agent, a resin, an organic solvent, a curing agent, and an auxiliary agent, and the like.

Optionally, the ozone-treated nano-zirconium oxide dispersion, the silane coupling agent, the resin, the organic solvent, the curing agent, and the auxiliary agent are respectively put into a ball mill, and the ball mill is controlled to perform ball milling treatment at a rotational speed of 200-2000 r/min, such as 500 r/min, 1000 r/min, or 1500 r/min for 10 to 60 minutes, such as 30 minutes, 40 minutes, or 50 minutes respectively to obtain the ball-milled nano-zirconium oxide dispersion, the ball-milled silane coupling agent, the ball-milled resin, the ball-milled organic solvent, the ball-milled curing agent, and the ball-milled auxiliary agent.

It is to be noted that the ozone-treated nano-zirconium oxide dispersion is subjected to a ball milling treatment so that the surfaces of the nano-zirconium oxide particles contained therein are more completely contacted with other solutions such as the coupling agent. That is, the surface modification of the nano-zirconium oxide particles by the coupling agent is enhanced by a mechanical force method by the ball milling treatment, thereby further increasing the number of surface active sites of the nano-zirconium oxide particles and increasing the dispersibility of the nano-zirconium oxide particles.

204. Mixing the ball-milled nano-metal oxide dispersion with the ball-milled plurality of preset solutions according to a predetermined weight ratio to form a mixed solution.

Optionally, 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent are mixed to form the mixed solution.

Optionally, 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent, and 0.1-3 wt % of the ball-milled auxiliary agent are mixed to form the mixed solution.

205. Subjecting the mixed solution to heat treatment to obtain the high refractive index ink.

It can be appreciated that the above-described mixed solution is formed by ball milling respectively the ozone-treated nano-metal oxide dispersion and the plurality of preset solutions and mixing them. In order to make the contact between the ball-milled nano-metal oxide dispersion and the ball-milled plurality of preset solutions complete, the mixed solution may be stirred, for example, for 5 minutes, 10 minutes, 15 minutes, or the like, so that the mixed solution is uniformly mixed.

The stirred solution is subjected to a heating treatment. Specifically, the stirred mixed solution was heated at a temperature of 50-80 degrees Celsius for 1-1.5 hours to obtain the high refractive index ink. If the stirred mixed solution is heated in a water bath at 50-80 degrees Celsius, such as 50 degrees Celsius, 60 degrees Celsius, or 70 degrees Celsius for 1-1.5 hours, such as 1 hour or 1.5 hours, the resulting final product is the high refractive index ink.

The method for preparing the high refractive index ink according to the present embodiment differs from the method for preparing the high refractive index ink according to the previous embodiment in that in the previous embodiment, the ozone-treated nano-metal oxide dispersion and the plurality of preset solutions are first mixed to form a mixed solution, and then the mixed solution is ball milled; wile in this embodiment, the ozone-treated nano-metal oxide dispersion and the plurality of preset solutions are respectively subjected to ball milling treatment to obtain a mixture of the ball-milled nano-metal oxide dispersion and the ball-milled plurality of preset solutions.

Accordingly, embodiments of the present disclosure also provide a high refractive index ink. The high refractive index ink can be used to prepare a low reflection film layer, and a display panel prepared by using the low reflection film layer can reduce reflection of light, thereby improving brightness, clarity, and the like of the display panel, so that the display panel achieves a better display effect.

Optionally, the high refractive index ink is prepared by an inorganic nanocomposite resin system including 5-30 wt % of the ozone-treated metal oxide dispersion, 0.1-10 wt % of the coupling agent, 5-30 wt % of the resin, 10-40 wt % of the organic solvent, 0.1-3 wt % of the curing agent, and 0.1-3 wt % of the auxiliary agent.

The ozone-treated nano-metal oxide dispersion is obtained by performing ozone treatment on the nano-metal oxide dispersion, which may be a nano-sized metal oxide dispersion, such as a nano-zirconium oxide dispersion. The purpose of ozone treatment on the nano-metal oxide dispersion is to solve the problem that the nano-metal oxide dispersion such as the nano-zirconium oxide dispersion is difficult to modify due to less surface active sites. Specifically, based on the strong oxidation of the ozone gas, the nano-zirconium oxide particles in the nano-zirconium oxide dispersion are catalytically reacted with the ozone gas, a plurality of hydroxyl radicals are generated on the surface of the nano-zirconium oxide particles, and the plurality of hydroxyl radicals have an extremely strong ability to obtain electrons; that is, the oxidation ability, so that the surface of the nano-zirconium oxide particles forms a plurality of active sites under the action of electron loss, so that the surface of the nano-zirconium oxide particles is better modified by ozone treatment to obtain a final product after the catalytic reaction; that is, the ozone-treated nano-zirconium oxide dispersion.

Specifically, the coupling agent can be used as a surface modifier, which can improve the dispersion and adhesion property of an inorganic metal oxide. The coupling agent may include a silane coupling agent. The silane having an epoxy end or an amino end is generally selected as the silane coupling agent, for example, a silane coupling agent KH-550, a silane coupling agent KH-560, and the like. The silane coupling agent KH-550 (i.e., γ-aminopropyltriethoxysilane) and the silane coupling agent KH-560 (i.e., γ-glycidoxypropyltrimethoxysilane) are desirable adhesives.

The resin may include at least one of an epoxy acrylate resin and a polyurethane acrylate resin. The epoxy acrylate resin is a modified epoxy resin obtained by reacting epoxy resin and acrylic acid and dissolving them in styrene, and it has desirable curability and moldability. The molecule of the polyurethane acrylate resin contains acrylic functional group(s) and urethane bond(s), and thus the cured adhesive has high abrasion resistance, adhesion, flexibility and peel strength and excellent low temperature resistance of the polyurethane, as well as excellent optical performance and weather resistance of the polyacrylate, so it is a radiation curable material with excellent comprehensive properties.

The organic solvent may include at least one of an ester solvent, an alcohol solvent, and an ether solvent, also may be a ketone solvent, an aromatic hydrocarbon solvent, or an amide solvent. The ester solvent may include propylene glycol methyl ether acetate, ethyl acetate, butyl acetate, and so on. The alcohol solvent may include methanol, ethanol, propanol, n-butanol, and so on. The ether solvent may include tetrahydrofuran, propylene glycol methyl ether, ethylene glycol monomethyl ether, and diethylene glycol monobutyl ether, and so on. The ketone solvent may include acetone, butanone, methyl isobutyl ketone, and so on. The aromatic hydrocarbon solvent may include toluene, xylene, ethylbenzene, and so on. The amide solvent may include dimethylformamide, N-dimethylammonium acetate, N-methylpyrrolidone, and so on. The organic solvent can serve to dilute and adjust the viscosity of the high refractive index ink.

The curing agent may be an ambient curing agent or a heat curing agent. The curing agent may include isocyanates, fatty amines, polyamides, polyamines, anhydrides, and so on. The addition of the curing agent allows these resins to undergo an irreversible process of change to achieve curing and cross-linking.

The auxiliary agent may include at least one of a leveling agent, a wetting agent, and an antistatic agent. The leveling agent can effectively reduce the surface tension of the high refractive index ink, and improve the leveling property and uniformity thereof. The wetting agent, as a surfactant, can also reduce the surface tension of the high refractive index ink. The antistatic agent can reduce the surface electrostatic accumulation of the high refractive index ink and improve the stability thereof.

Specifically, 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent are mixed to form a mixed solution. The mixed solution is put into a ball mill, with controlling the ball mill to perform ball milling treatment at a rotational speed of 200-2000 r/min for 10 to 60 minutes to obtain the ball-milled mixed solution. The ball-milled mixed solution is removed from the ball mill tank of the ball mill and heated in a water bath at 50-80 degrees Celsius for 1 hour. The final product obtained is a high refractive index ink.

The high refractive index ink and the preparation method thereof provided in the above embodiments are both for obtaining a high refractive index ink capable of preparing a low reflective film layer, and the low reflective film layer is used for a display panel, thereby causing the display panel to reduce reflection of light rays, improving brightness, clarity, and the like of the display panel, thereby achieving a desirable display effect of the display panel.

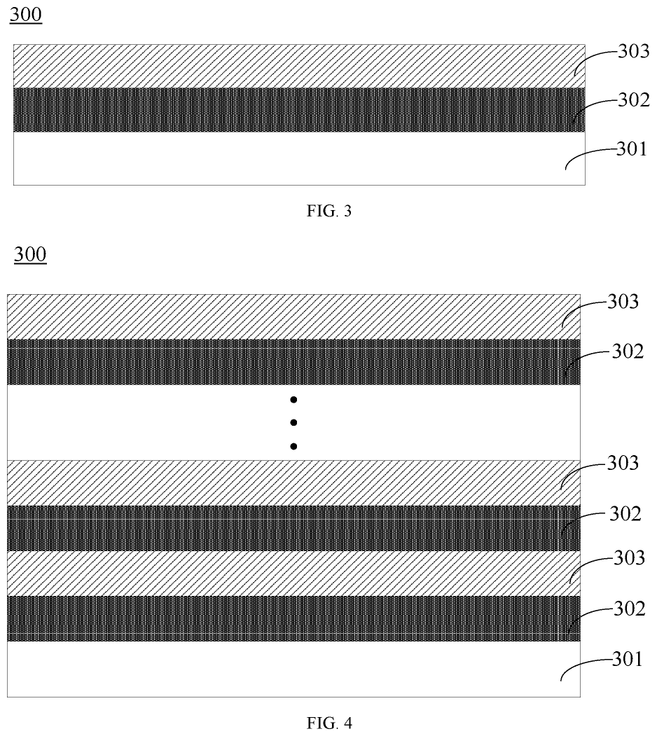

To this end, the embodiment of the present disclosure further provides a display panel. Referring to FIG. 3, it is a schematic view of a first structure of a display panel according to an embodiment of the present disclosure. The display panel 300 may be an LCD display panel, an OLED display panel, a Mirco LED display panel, an LED display panel, or the like. The display panel 300 may include a substrate base 301, a first film layer 302, and a second film layer 303.

Optionally, the substrate base 301 may be a glass base or the like.

Optionally, the first film layer 302 may be disposed on the substrate base 301. The first film layer 302 is prepared by a high refractive index ink provided of by the preparation method thereof in the above embodiment. Specifically, the high refractive index ink may be coated on the substrate base 301, for example, by spraying or roller coating, and then the high refractive index ink may be made into a film, i.e., the first film layer 302, by heating or UV curing.

The high refractive index ink may be provided by providing a nano-metal oxide dispersion; performing ozone treatment on the nano-metal oxide dispersion to obtain the ozone treated nano-metal oxide dispersion; mixing the ozone-treated nano-metal oxide dispersion with a plurality of preset solutions according to a predetermined weight ratio to form a mixed solution; performing ball milling treatment on the mixed solution to obtain the ball-milled mixed solution; subjecting the ball-milled mixed solution to a heating treatment to obtain a high refractive index ink.

Specifically, the high refractive index ink is prepared by an inorganic nanocomposite resin system and includes 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent.

Optionally, the second film layer 303 is disposed on the side of the first film layer 302 away from the substrate base 301, wherein the refractive index of the second film layer 303 is less than the refractive index of the first film layer 302.

By providing a laminated structure of the high-refractive-index first film layer 302 and the low-refractive-index second film layer 303 on the substrate base 301, when the ambient light is incident from the side of the second film layer 303 away from the first film layer 302, interference destruction is generated at the interface at which the first film layer 302 and the second film layer 303 contact each other, thereby reducing reflection of the ambient light and improving the display effect of the display panel 300.

If the refractive index of the first film layer 302 is A, the refractive index of the second film layer 303 is B, and A is greater than B, the wave train W of the ambient light; that is, the incident light, is reflected on the upper surface of the second film layer 303 to form a reflected light wave W1. The incident light is reflected again when transmitting through the second film layer 303 to the upper surface of the first film layer 302, and then the reflected light passes through the upper surface of the second film layer 303 again to generate the reflected light wave W2. W1 and W2 are separated from the same wavelength band, so that their frequencies are the same, and the direction of vibration is the same. The difference between W1 and W2 is the phase difference; that is, the wave path difference. When the wave path difference meets an odd multiple of the half wavelength of the wave train W, interference destruction is generated at the interface between the first film layer 302 and the second film layer 303, that is, the upper surface of the first film layer 302, so that the reflected wave W2 is almost zero. That is, more light is irradiated to the substrate base 301, thereby improving the brightness of the display panel 300, and further improving the display effect of the display panel 300.

To further improve the display effect of the display panel 300, more laminated structures of the first film layer 302 and the second film layer 303 may be provided to achieve interference destruction. Specifically, referring to FIG. 4, it is a schematic view of a second structure of a display panel according to an embodiment of the present disclosure. The display panel 300 may include a plurality of first film layers 302 and a plurality of second film layers 303.

The plurality of first film layers 302 and the plurality of second film layers 303 are stacked in sequence, and two adjacent first film layers 302 or two adjacent second film layers 303 are spaced apart from each other. If the display panel 300 comprises two first film layers 302 and two second film layers 303, the arrangement order of the two first film layers 302 and the two second film layers 303 on the substrate base 301 is sequentially the substrate base 301-one first film layer 302-one second film layer 303-one first film layer 302-one second film layer 303.

It is to be noted that the destructive interference of light is generated only at the contact interface of the film layers of different refractive indices, and the incident sequence of light needs to be from the film layers of low refractive index into the film layers of high refractive index. Therefore, the number of the plurality of first film layers 302 and the plurality of second film layers 303 need to be the same, that is, one first film layer 302 corresponds to one second film layer 303. A second film layer 303 located farthest from the substrate base 301 is located at the light-entering surface of a first film layer 302 located farthest from the substrate base 301.

From the above discussion, in the present embodiment, the first film layer 302 and the second film layer 303 with different refractive indices are provided on the substrate base 301, so that the reflection of ambient light can be reduced by the destructive interference of the first film layer 302 and the second film layer 303. By providing a laminated structure of a plurality of groups of the first film layer 302 and the second film layer 303, multiple destructive interference with the first film layers 302 and the second film layers 303 can be realized, thereby further reducing reflection of ambient light, improving the brightness of the display panel 300, and further improving the display effect of the display panel 300.

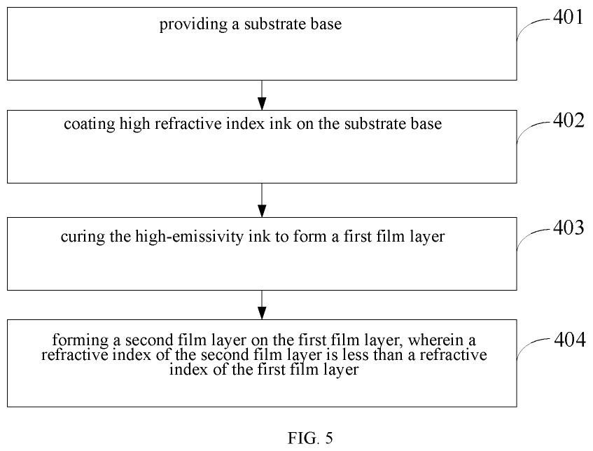

Accordingly, an embodiment of the present disclosure further provides a method for preparing a display panel. Referring to FIG. 5, it is a schematic flowchart of a method for preparing a display panel according to an embodiment of the present disclosure. The display panel 300 may be a LCD display panel, an OLED display panel, a Mirco LED display panel, a LED display panel, or the like. The specific steps of the preparation method of the display panel may be as follows:

401. Providing a substrate base

In this embodiment, the substrate base 301 may be a glass base.

402. Coating a high refractive index ink on the substrate base

The high refractive index ink is coated on the substrate base 301, for example, by spray coating or roll coating. The high refractive index ink may be prepared by providing a nano-metal oxide dispersion; performing ozone treatment on the nano-metal oxide dispersion to obtain the ozone treated nano-metal oxide dispersion; mixing the ozone-treated nano-metal oxide dispersion with a plurality of preset solutions according to a predetermined weight ratio to form a mixed solution; performing ball milling treatment on the mixed solution to obtain the ball-milled mixed solution; performing heating treatment on the ball-milled mixed solution to obtain the high refractive index ink.

Specifically, the high refractive index ink is prepared by an inorganic nanocomposite resin system, and includes 5-30 wt % of the ozone-treated nano-metal oxide dispersion, 0.1-10 wt % of a coupling agent, 5-30 wt % of a resin, 10-40 wt % of an organic solvent, and 0.1-3 wt % of a curing agent and 0.1-3 wt % of an auxiliary agent.

403. Curing the high refractive index ink to form a first film layer.

The high refractive index ink is formed into a film by a curing process such as heating or UV curing, that is, the first film layer 302 is formed.

404. Forming a second film layer on the first film layer, wherein the refractive index of the second film layer is less than the refractive index of the first film layer.

The second film layer 303 is deposited on the side of the first film layer 302 away from the substrate base 301, wherein the refractive index of the second film layer 303 is less than the refractive index of the first film layer 302.

By providing a laminated structure of the high-refractive-index first film layer 302 and the low-refractive-index second film layer 303 on the substrate base 301, when the ambient light enters from the side of the second film layer 303 away from the first film layer 302, interference destruction is generated at the interface at which the first film layer 302 and the second film layer 303 contact each other, thereby reducing reflection of the ambient light, and improving the display effect of the display panel 300.

To further improve the display effect of the display panel 300, more such laminated structures of the first film layer 302 and the second film layer 303 may be provided to achieve interference destruction. Specifically, referring to FIG. 4, the display panel 300 may include a plurality of first film layers 302 and a plurality of second film layers 303.

The plurality of first film layers 302 and the plurality of second film layers 303 are stacked in sequence, and two adjacent first film layers 302 or two adjacent second film layers 303 are spaced apart from each other. If the display panel 300 comprises two first film layers 302 and two second film layers 303, the arrangement order of the two first film layers 302 and the two second film layers 303 on the substrate base 301 is sequentially the substrate base 301-one first film layer 302-one second film layer 303-one first film layer 302-one second film layer 303.

It is to be noted that the destructive interference of light is generated only at the contact interface of the film layers of different refractive indices, and the incident sequence of light needs to be from the film layers of low refractive index to the film layers of high refractive index. Therefore, the number of the plurality of first film layers 302 and the plurality of second film layers 303 need to be the same; that is, one first film layer 302 corresponds to one second film layer 303. A second film layer 303, which is farthest from the substrate base 301, may directly receive light irradiation.

From the above discussion, in the present embodiment, a substrate base is provided, a high refractive index ink is coated on the substrate base, and cured to form a first film layer; a second film layer is formed on the first film layer, wherein the refractive index of the second film layer is less than that of the first film layer. In this embodiment, the first film layer 302 and the second film layer 303 having different refractive indices are provided on the substrate base 301, and the reflection of ambient light can be reduced by the destructive interference of the first film layer 302 and the second film layer 303. By providing a laminated structure of a plurality of groups of the first film layers 302 and the second film layers 303, multiple destructive interference of the first film layers 302 and the second film layers 303 can be realized, thereby further reducing reflection of ambient light, improving the brightness of the display panel 300, and further improving the display effect of the display panel 300.

In the above-mentioned embodiments, the description of each embodiment has its own emphasis, and parts not described in detail in a certain embodiment may be referred to the related description of other embodiments.

The above embodiments of the present disclosure provide a detailed description of the high refractive index ink and its preparation method, a display panel and its preparation method, and specific examples are applied herein to illustrate the principles and implementation of the present disclosure. The description of the above embodiments is merely intended to help understand the method of the present disclosure and the core idea thereof. Meanwhile, variations will occur to those skilled in the art in both the detailed description and the scope of application in accordance with the teachings of the present disclosure. In summary, the present description should not be construed as limiting the present disclosure.

What is claimed is:

1. A method for preparing high refractive index ink, comprising steps of:
providing a nano-metal oxide dispersion;
performing ozone treatment on the nano-metal oxide dispersion to obtain the ozone treated nano-metal oxide dispersion;
mixing the ozone-treated nano-metal oxide dispersion with a plurality of preset solutions according to a predetermined weight ratio to form a mixed solution;
performing ball milling treatment on the mixed solution to obtain the ball-milled mixed solution; and
heating the ball-milled mixed solution to obtain the high refractive index ink.

2. The method for preparing high refractive index ink according to claim 1, wherein the step of performing ozone treatment on the nano-metal oxide dispersion to obtain the ozone treated nano-metal oxide dispersion comprises:
feeding ozone gas into the nano-metal oxide dispersion over a predetermined time; and
stirring the nano-metal oxide dispersion and the ozone gas to obtain the ozone treated nano-metal oxide dispersion.

3. The method for preparing high refractive index ink according to claim 2, wherein the stirring is performed for 10-60 minutes.

4. The method for preparing high refractive index ink according to claim 2, wherein the plurality of preset solutions include a coupling agent, a resin, an organic solvent, and a curing agent, wherein the ozone-treated nano-metal oxide dispersion includes the ozone-treated nano-zirconium oxide dispersion, the coupling agent includes a silane coupling agent, the resin includes at least one of an epoxy acrylate resin and a polyurethane acrylate resin, the organic solvent includes at least one of an ester solvent, an alcohol solvent, and an ether solvent, and the curing agent includes an isocyanate;
wherein the step of mixing the ozone-treated nano-metal oxide dispersion with the plurality of preset solutions according to the predetermined weight ratio to form the mixed solution comprises:
mixing 5-30 wt % of the ozone-treated nano-zirconium oxide dispersion, 0.1-10 wt % of the silane coupling agent, 5-30 wt % of the resin, 10-40 wt % of the organic solvent, and 0.1-3 wt % of the curing agent to form the mixed solution.

5. The method for preparing high refractive index ink according to claim 4, wherein the plurality of preset solutions further include an auxiliary agent including at least one of a leveling agent, a wetting agent, and an antistatic agent;
wherein the step of mixing the ozone-treated nano-metal oxide dispersion with the plurality of preset solutions according to the predetermined weight ratio to form the mixed solution comprises:
mixing 5-30 wt % of the ozone-treated nano-zirconium oxide dispersion, 0.1-10 wt % of the silane coupling agent, 5-30 wt % of the resin, 10-40 wt % of the organic solvent, 0.1-3 wt % of the curing agent, and 0.1-3 wt % of the auxiliary agent to form the mixed solution.

6. The method for preparing high refractive index ink according to claim 4, wherein the step of performing ball milling treatment on the mixed solution to obtain the ball-milled mixed solution comprises:
putting the mixed solution into a ball mill, and controlling the ball mill to perform ball milling treatment at a rotational speed of 200-2000 r/min for 10 to 60 minutes to obtain the ball-milled mixed solution.

7. The method for preparing high refractive index ink according to claim 5, wherein the step of performing ball milling treatment on the mixed solution to obtain the ball-milled mixed solution comprises:
putting the mixed solution into a ball mill, and controlling the ball mill to perform ball milling treatment at a rotational speed of 200-2000 r/min for 10 to 60 minutes to obtain the ball-milled mixed solution.

8. The method for preparing high refractive index ink according to claim 6, wherein the step of heating the ball-milled mixed solution to obtain the high refractive index ink comprises:
heating the ball-milled mixed solution at a temperature of 50-80 degrees Celsius for 1-1.5 hours to obtain the high refractive index ink.

9. The method for preparing high refractive index ink according to claim 7, wherein the step of heating the ball-milled mixed solution to obtain the high refractive index ink comprises:
heating the ball-milled mixed solution at a temperature of 50-80 degrees Celsius for 1-1.5 hours to obtain the high refractive index ink.

10. A method for preparing high refractive index ink, comprising steps of:
providing a nano-metal oxide dispersion;
performing ozone treatment on the nano-metal oxide dispersion to obtain the ozone treated nano-metal oxide dispersion;
separately performing ball milling treatment on the ozone-treated nano-metal oxide dispersion and a plurality of preset solutions to obtain the ball-milled nano-metal oxide dispersion and the ball-milled plurality of preset solutions;
mixing the ball-milled nano-metal oxide dispersion with the ball-milled plurality of preset solutions according to a predetermined weight ratio to form a mixed solution;
heating the mixed solution to obtain the high refractive index ink.

11. The method for preparing high refractive index ink according to claim 10, wherein the plurality of preset solutions include a coupling agent, a resin, an organic solvent, and a curing agent, wherein the ozone-treated nano-metal oxide dispersion includes the ozone-treated nano-zirconium oxide dispersion, the coupling agent includes a silane coupling agent, the resin includes at least one of an epoxy acrylate resin and a polyurethane acrylate resin, the organic solvent includes at least one of an ester solvent, an alcohol solvent, and an ether solvent, and the curing agent includes an isocyanate;
wherein the step of separately performing ball milling treatment on the ozone-treated nano-metal oxide dispersion and the plurality of preset solutions to obtain the ball-milled nano-metal oxide dispersion and the ball-milled plurality of preset solutions comprises:
controlling a ball mill to perform ball milling treatment on the ozone-treated nano-zirconium oxide dispersion, the silane coupling agent, the resin, the organic solvent, and the curing agent at a rotational speed of 200-2000 r/min for 10-60 minutes to obtain the ball-milled nano-zirconium oxide dispersion, the ball-milled silane coupling agent, the ball-milled resin, the ball-milled organic solvent, and the ball-milled curing agent.

12. The method for preparing high refractive index ink according to claim 11, wherein the plurality of preset solutions further include an auxiliary agent including at least one of a leveling agent, a wetting agent, and an antistatic agent;
wherein the step of separately performing ball milling treatment on the ozone-treated nano-metal oxide dispersion and the plurality of preset solutions to obtain the ball-milled nano-metal oxide dispersion and the ball-milled plurality of preset solutions comprises:
controlling the ball mill to perform ball milling treatment on the ozone-treated nano-zirconium oxide dispersion, the silane coupling agent, the resin, the organic solvent, and the curing agent, and the auxiliary agent at a rotational speed of 200-2000 r/min for 10 to 60 minutes to obtain the ball-milled nano-zirconium oxide dispersion, the ball-milled silane coupling agent, the ball-milled resin, the ball-milled organic solvent, the ball-milled curing agent, and the ball-milled auxiliary agent.

13. The method for preparing high refractive index ink according to claim 11, wherein the step of mixing the ball-milled nano-metal oxide dispersion with the ball-milled plurality of preset solutions according to the predetermined weight ratio to form the mixed solution comprises:
mixing 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent to form the mixed solution.

14. The method for preparing high refractive index ink according to claim 12, wherein the step of mixing the ball-milled nano-metal oxide dispersion with the ball-milled plurality of preset solutions according to the predetermined weight ratio to form the mixed solution comprises:
mixing 5-30 wt % of the ball-milled nano-zirconium oxide dispersion, 0.1-10 wt % of the ball-milled silane coupling agent, 5-30 wt % of the ball-milled resin, 10-40 wt % of the ball-milled organic solvent, and 0.1-3 wt % of the ball-milled curing agent and 0.1-3 wt % of the ball-milled auxiliary agent to form the mixed solution.

15. A display panel, comprising:
a substrate base;
a first film layer disposed on the substrate base, wherein the first film layer is prepared from high refractive index ink obtained by the method for preparing high refractive index ink according to claim 1;
a second film layer disposed on a side of the first film layer away from the substrate base, wherein a refractive index of the second film layer is less than a refractive index of the first film layer.

16. The display panel according to claim 15, wherein the display panel comprises a plurality of first film layers and a plurality of second film layers, wherein the plurality of first film layers and the plurality of second film layers are stacked in sequence, and two adjacent first film layers or two adjacent second film layers are disposed at intervals.
